(19) United States
(12) Patent Application Publication
(10) Pub. No.: US 2015/0321413 A1
(43) Pub. Date: Nov. 12, 2015

(54) MODULAR CONTROL SYSTEM OF AN INSTALLATION FOR PRODUCING CONTAINERS

(71) Applicant: SIDEL PARTICIPATIONS, Octeville Sur Mer (FR)

(72) Inventor: Thierry DEAU, Octeville Sur Mer (FR)

(73) Assignee: SIDEL PARTICIPATIONS, Octeville Sur Mer (FR)

(21) Appl. No.: 14/410,395

(22) PCT Filed: Jul. 9, 2013
(86) PCT No.: PCT/FR2013/051640

§ 371 Date: Dec. 22, 2014

(30) Foreign Application Priority Data
Jul. 13, 2012 (FR) 12 56833

(51) Int. Cl. B29C 49/64; B29C 49/78; B29C 49/06; G05B 19/418

(52) U.S. Cl. CPC B29C 49/6409; G05B 19/41875; B29C 49/783; B29C 49/06; G05B 2219/45244

(57) ABSTRACT

A control system (32) of an installation (1) for producing containers (2) from blanks (3) made from a thermoplastic material, the installation (1) including at least two units (4, 9) for processing the blanks (3) or the containers (2), each provided with at least one station (5, 10) for processing the blanks (3) or the containers (2), the control system (32) including a central control unit (33) of the installation (1), at least two control units (36, 46) slaved to the central control unit (33) and each associated respectively with a processing unit (9, 4), and at least two controllers (37, 47) each slaved to a control unit (36, 46) and each associated with at least one processing station (10, 5).

The invention relates to the field of producing containers from blanks made of thermoplastic material such as PET (polyethylene terephthalate), with the term “blank” covering both a preform that has been injected and an intermediate container that has undergone one or more temporary forming operations.

The production of containers is generally performed within an installation that comprises multiple units for processing blanks or containers, typically a unit for heating blanks to a temperature that is higher than the glass transition temperature of the material, or else a unit for forming containers from hot blanks, by blow molding or drawing-blow molding in molds by injection of a pressurized fluid (in particular a gas such as air).

The forming of the containers on the industrial scale imposes extremely short cycle times. For an ordinary modern production rate, on the order of 50,000 containers per hour, the cycle time, measured between the introduction of the blank into the mold and the evacuation of the formed container, is between 1 second and 2 seconds only.

Poor imprint-taking and poor distribution of the material (often correlated) are frequent shape defects. It is known that these defects can be linked to various machine parameters, in particular the temperature for heating blanks, the pressure and the flow rate of fluid, or else the drawing speed. These correlations are studied in particular in the documents WO 2008/081107 and WO 2012/035260 in the name of the applicant.

The regulation of each processing unit is conventionally entrusted to a specialized operator who is responsible for verifying that the processing is carried out in accordance with a predefined instruction (this instruction comprises, for example, in the heating unit, the heating temperature, the travel speed of the blanks, or else the power of the ventilation ensuring the evacuation of a portion of the heat; in the forming unit, the instruction comprises in particular the injection pressure, the drawing speed, and the temperature for regulation of the mold).

Manual corrections are generally applied to the instruction (to the extent that the parameters can be regulated) as a function of the perceived quality of the containers assessed in a subjective manner by the operator. The application of these corrections is a difficult problem, taking into account in particular the subjective nature of the perceived quality and the limited number of containers that are sampled to check the production rates (several tens of thousands per hour). Actually, the elapsed time between the report of a defect on a series of containers and the effective application of an instruction that is modified manually by the operator can end in the scrapping of several hundred containers produced in the interval.

An automation of the regulations is under study, owing to a strict and systematic analysis of curves characterizing the change in parameters such as the temperature of the blanks at the outlet of the heating unit, carried out by means of thermal cameras, or else the injection pressure, carried out in the mold by means of pressure sensors, cf. the above-mentioned documents.

This automation poses problems of implementation, however, in particular when a drift noted on a processing unit requires a transverse retroaction, i.e., a modification of the instruction applied to another processing unit. In practice, this problem takes place, for example, when it is desired to recalibrate a blow-molding curve (i.e., a curve showing, over a cycle, the changes in the pressure measured in the mold, a parameter that is linked to the forming unit) to a theoretical curve by correcting a parameter linked to the heating unit (typically the heating temperature, regulated by modification of the emission power of electromagnetic radiation sources in front of which the blanks pass).

At this time, there is no solution making it possible to initiate in a reliable and automated manner such a transverse retroaction.

A first object of the invention is to optimize the control of an installation for producing containers.

A second object of the invention is to optimize the quality of the containers produced.

A third object is, more specifically, to make possible a transverse retroaction of the various processing units of the installation, as a function of drifts noted in production.

For this purpose, in the first place, a control system of an installation for producing containers from blanks made of thermoplastic material is proposed, with this installation comprising at least two units for processing blanks or containers, each equipped with at least one station for processing blanks or containers, this control system comprising a central control unit of the installation, at least two control units tied to the central control unit and each associated respectively with a processing unit, and at least two controllers each tied to a control unit and each associated with at least one processing station.

This architecture makes it possible in particular to divide the tasks for control within an installation for producing containers, for the benefit of a better control of the installation and of the quality of the containers produced.

Various additional characteristics can be provided, by themselves or in combination:
The central control unit is programmed for:
   Directing each attached control unit according to a processing instruction that is loaded into the control unit,
   Taking into account at least one characteristic point in the central unit by the control unit,
   Comparing this characteristic point with a theoretical point,
   If a variation is declared between the characteristic point and the theoretical point, issuing a corrected processing instruction intended for a second control unit,
   Loading the corrected processing instruction into the second control unit;
Each control unit is programmed for:
   Directing each attached controller according to the processing instruction that is loaded by the central unit,
   Taking into account at least one singular point obtained from a measurement made on at least one processing station for control of a controller,
   Calculating a characteristic point as a function of the singular point(s),
   Comparing the characteristic point with a theoretical point,
   If a variation is declared between the characteristic point and the theoretical point justifying a modification of the processing instruction of another processing unit, communicating the characteristic point to the central control unit;
Each controller is programmed for:
   Directing at least one processing station according to the processing instruction,
   Controlling at least one measurement at the level of the processing station,
   Based on this measurement, plotting a curve describing a variation of this measurement,
   Analyzing the curve and extracting from it the coordinates of a singular point,
   Communicating the singular point to the control unit.

Secondly, an installation for producing containers from blanks made of thermoplastic material is proposed, with this installation comprising at least two units for processing blanks or containers (for example, a unit for heating blanks and a forming unit equipped with at least one station for forming containers from blanks), each equipped with at least one station for processing blanks or containers, and a control system according to one of the preceding claims.

Other objects and advantages of the invention will be brought out in the description of a preferred embodiment, given below with reference to the accompanying drawings, in which:

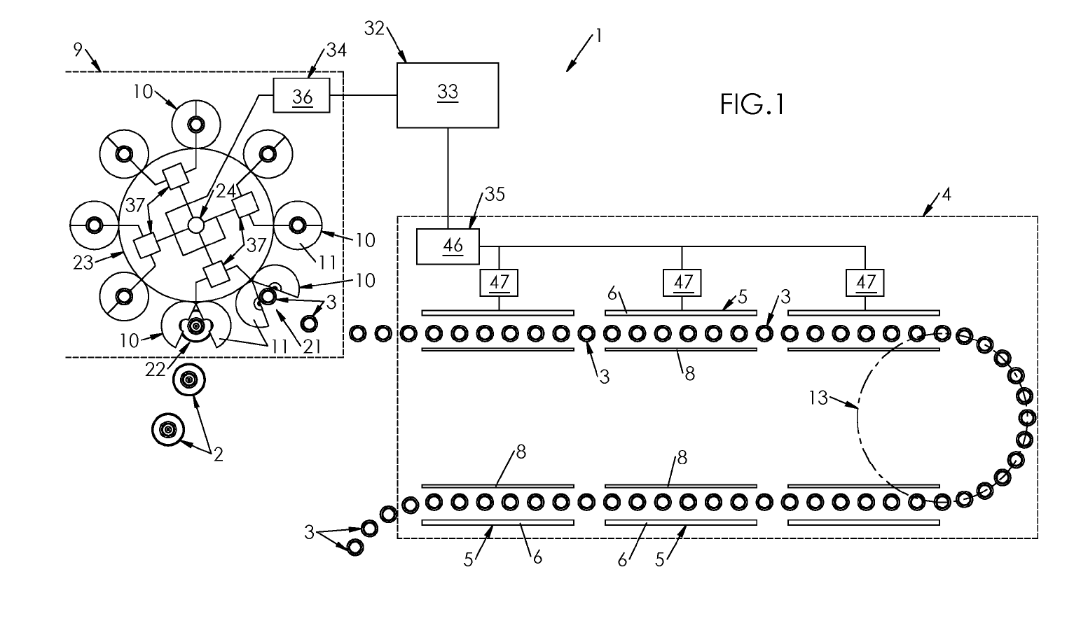

FIG. 1 is a diagrammatic view showing an installation for producing containers, comprising a forming unit and a heating unit;

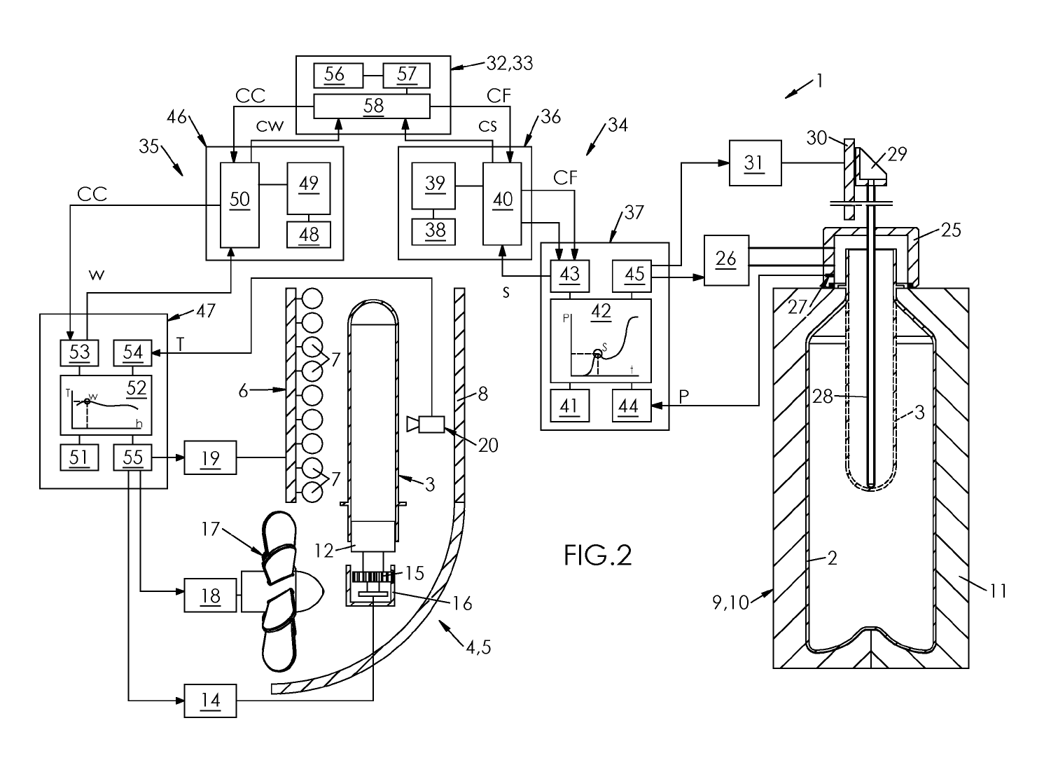

FIG. 2 is a diagrammatic view illustrating in greater detail the architecture of the installation;

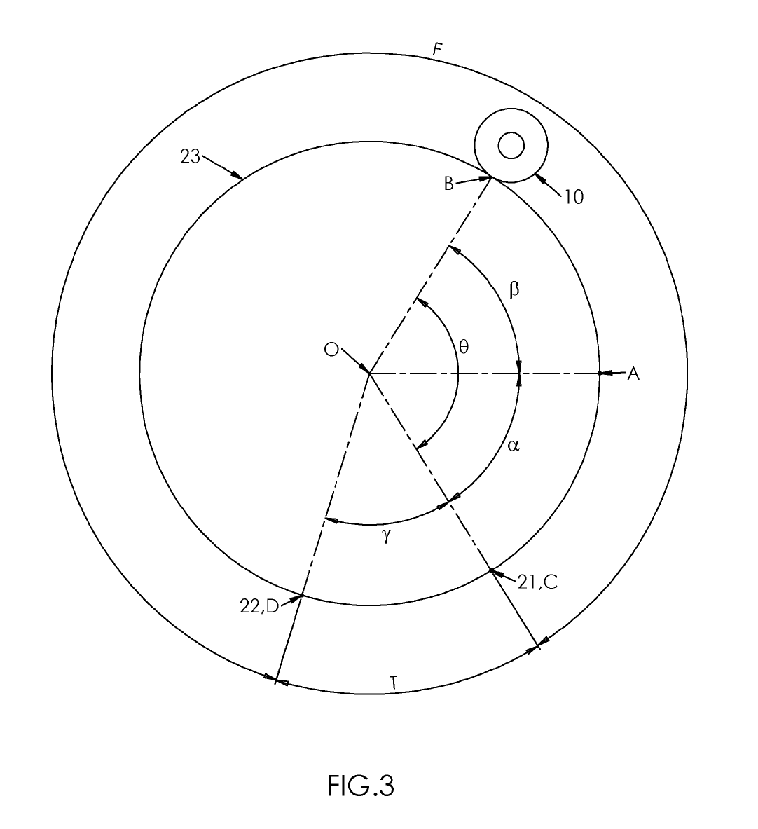

FIG. 3 is a diagrammatic view illustrating the angular positions of a wheel of the forming unit.

FIGS. 1 and 2 diagrammatically show an installation 1 for producing containers 2 from blanks 3 made of thermoplastic material, for example made of PET (polyethylene terephthalate).

The installation 1 comprises at least two units 4, 9 for processing containers 2 or blanks 3. For the sake of simplicity, it is assumed below that the blanks 3 are preforms.

Typically, as in the illustrated example, the installation comprises:
A heating unit 4 or oven, which comprises a series of heating modules 5, each having a radiant wall 6 equipped with superposed sources 7 of infrared radiation and a reflecting wall 8 placed facing the radiant wall 6 for reflecting the portion of radiation that is not absorbed by the preforms 3,
A unit 9 for forming by blow molding or drawing-blow molding, equipped with at least one forming station 10 (and in this case a series of stations), with the forming station or each forming station 10 being equipped with a mold 11 with the imprint of a container.

In a standard way, the preforms 3 at ambient temperature are introduced into the oven 4 by an input of the latter, for example by means of a wheel or a supply conveyor. Then, the preforms 3 are heated in a stream in the oven 4 at a temperature higher than the glass transition temperature of the material (the final temperature of the blanks is on the order of 120° C. for the PET, whose glass transition temperature is approximately 80° C.).

In the oven 4, the preforms 3 are mounted, for example, on pivoting supports 12 or spinners. Each spinner 12 is mounted on a chain circulating on a driving wheel 13 driven in rotation by a motor 14. The spinner 12 is equipped with a pinion 15 that engages a rack 16 to drive the spinner 12 in rotation during its passage into the oven 4 and thus to expose the surface of each preform 3 to radiation.

To evacuate at least a portion of the excess heat produced by the radiant wall 6, the oven 4 can be equipped with an extraction system comprising, for example, a fan 17 driven by a motor 18 and positioned facing the necks of the preforms 3.

In addition, the power of the radiation emitted by the radiant wall 6 can be modulated by means of a power variable-speed drive unit 19, as in the example embodiment illustrated in FIG. 2.

The thermal profile of the preforms 3 is preferably controlled, either directly in the oven 4 or at the outlet of the latter, by means of a thermal sensor 20. According to an illustrated embodiment in FIG. 2, the thermal sensor 20 is a thermal camera pointing toward the preforms 3.

At the outlet of the oven 4, the thus heated preforms 3 are transferred to the forming unit 9 via a transfer unit (such as a transfer wheel) to be blow-molded or drawn-blow-molded individually in a mold 11. The preforms 3 are introduced into the forming unit 9 at a loading point 21.

At the end of the forming, the containers 2 are evacuated from the molds 11 from an unloading point 22 for the purpose of being directly filled and labeled, or stored temporarily for the purpose of being filled and subsequently labeled. Once filled and labeled, the containers are grouped and packaged, for example, within a plastic-wrapping unit that envelops each group of containers in a heat-shrinkable film.

As is also seen in FIGS. 1 and 2, the forming unit 9 comprises a pivoting wheel 23 on which are mounted the forming stations 10 and a sensor 24 to detect the instantaneous angular position of the wheel 23, in the form of, for example, a coder (i.e., in practice, an instrument-equipped bearing device).

Each forming station 10 is equipped with a nozzle 25, by which a fluid (in particular a gas such as air) is injected into the mold 11. Each forming station 10 is also equipped with an injection device comprising an actuator block 26 connected to the nozzle 25 for controlling the injection of the fluid. In addition, each forming station 10 is equipped with a device 27 for measuring the prevailing pressure in the container during forming. In the illustrated example, the measuring device 27 comprises a pressure sensor mounted on the nozzle 25, in which the pressure in the course of forming is identical to the pressure prevailing in the container 2.

According to an embodiment corresponding to a process for forming by drawing-blow molding, each forming station 10 also comprises a moving drawing rod 28, integral with a carriage 29 mounted in translation relative to a support 30.

The movement of the rod 28 is controlled in an electromagnetic manner. For this purpose, the support 30 comprises an electromagnetic track connected to a motor 31, and the carriage 29 itself is magnetic. The sign and the power of the current passing through the track make it possible to move the rod 28 along a predetermined movement profile, comprising a direction and a speed of motion.

As illustrated in FIG. 1, the forming stations 10 describe a path (in this case circular) that includes a forming sector F extending from the loading point 21 of the preforms 3 to the unloading point 22 of the containers 2 that are formed, and a buffer sector T, complementary to the forming sector F and extending from the unloading point 22 to the loading point 21.

The installation 1 is equipped with a control system 32 that comprises a central unit 33 for control of the installation 1, and, for each processing unit 4, 9, a dedicated control system 34, 35 that in an automatic way directs the operation of the respective unit 9, 4.

Thus, the forming unit 9 is equipped with a dedicated control system 34 that comprises a master control unit 36 and a series of slave controllers 37 tied to the master control unit 36.

The master control unit 36 is computerized and comprises, as illustrated in FIG. 2:
A memory 38 into which programs for directing the forming unit 9 are entered,
A processor 39 connected to the memory 38 for applying the instructions of the programs, and
A communication interface 40 connected to the processor 39 for communication with external communicating entities, as will be explained below.

Each slave controller 37 is a programmable logic controller of the type described in W. Bolton, Programmable Logic Controllers, Newnes, 5^{th} Edition, 2009.

More specifically, each controller 37 comprises:
A memory 41 into which programs for directing at least one forming station 10 are entered,
A processor 42 connected to the memory 41 for applying the instructions of the program,
A communication interface 43 connected to the processor 42 for communication with the master control unit 36 via the communication interface 40,
An input interface 44 connected, on the one hand, to the processor 42, and, on the other hand, to the device 27 for measuring the pressure, denoted P, prevailing in the mold 11,
An output interface 45 connected, on the one hand, to the processor 42 and, on the other hand, to the actuator block 26 and to the control motor 31 of the drawing rod 28.

As a variant, the input and output interfaces 44, 45 are assembled within an input/output unit interface.

The controller 37 is programmed to carry out the following operations:
Directing the forming station 10 with which it is associated (or each forming station 10 with which it is associated; the controller 37 can, for example, be associated with two forming stations 10) for performing a complete forming cycle along the forming sector F, from the loading of a preform 3 at the loading point 21 to the unloading of the formed container 2 at the unloading point 22, according to a forming instruction CF that is loaded (i.e., written) into the memory 41;
Taking into account a measurement of the pressure P in the mold 11. The measurement of pressure is carried out by the pressure sensor 27 continuously or in a sequential and uniform manner, at predetermined intervals (for example, 5 ms) and communicated to the processor 42 via the input interface 44;
Based on the measurement of pressure, plotting during the forming cycle a blow-molding curve describing the changes in the fluid pressure P in the mold 11 at any time, denoted t (in practice, at times, measured by the internal clock of the processor 42, corresponding to the angular positions provided by the sensor 27), this curve (diagrammatically visible in FIG. 2) being plotted by the processor 42 and memorized during the cycle;
Analyzing, at the end of the cycle, the blow-molding curve and extracting from it the coordinates of at least one singular point S (in particular, a local pressure peak, typically a point B as defined in the international application WO 2008/081107);
Communicating, from the end of the cycle, the coordinates of the singular point to the master control unit 36.

The forming instruction can comprise pressure values and/or the flow rate of fluid delivered by the actuator block 26 or else a movement profile of the rod 28 or of any other moving part (for example, a mold bottom coupled to the rod 28), in the form of, for example, a speed curve of the motion of the rod 28 (or of any other moving part) based on its position. The speed of motion of the rod 28 (or of any other moving part) can be converted by the processor 42 of the controller 37 into power to be delivered by the motor 31. The instruction is applied by the processor 42, which directs the actuator block 26 and the motor 31 via the output interface.

The processor 39 of the master control unit 36 is, for its part, programmed for:
Directing its slave controllers 37,
Taking into account the singular point or each singular point S communicated by each controller 37 at the end of the cycle performed by the forming station or each associated forming station 10,
Calculating a characteristic point CS from the singular point(s) S. This characteristic point CS can be the singular point S itself, communicated during a single cycle by a controller 37, or an average of singular points S communicated during multiple successive cycles by the same controller 37, or an average of singular points S communicated during a single cycle by multiple controllers 37, or else an average of singular points S communicated during multiple successive cycles by multiple controllers 37;
Comparing this characteristic point CS, obtained (or calculated based on) measurements, with a theoretical point entered in advance into the memory 38 of the master control unit 36 and corresponding to a model container,
If a variation is declared between the characteristic point CS and the theoretical point, issuing a corrected forming instruction CF, comprising a pressure value and/or a fluid flow rate value that is modified to be delivered by the actuator block 26, or a control time of the actuator block 26, or else a movement profile of the rod 28 (for example, in the form of a speed curve of the rod 28 or a power curve of the motor 31, as a function of the position of the rod 28), or another moving part;
Loading the corrected forming instruction CF into the controller or each controller 37 directed by the master control unit 36,
If necessary, communicating the characteristic point CS to the central control unit 33.

When no variation is declared between the characteristic point CS and the theoretical point, no corrected forming instruction is issued by the processor 39, in such a way that for the new forming cycle or multiple subsequent forming cycles, the slave controller 37 applies the forming instruction CF of the preceding cycle(s).

On the assumption, mentioned above, of a correction of the forming instruction CF, the new instruction CF is loaded into the slave controller 37 when the associated forming station 10 is in the buffer sector T, in such a way as to be able to be applied for the following forming cycle, from the loading of a new preform 2 at the loading point 21.

The angular position information of the wheel 23 is common to the controllers 37 and shared. It can be centralized at the level of the master control unit 36, whose processor 39 in this case is programmed to communicate, at predetermined intervals (in particular several milliseconds, for example 1 ms), via its communication interface 40, the instantaneous angular position of the wheel 23, as measured by the angular position sensor 24 in a polar coordinate frame of reference centered on the axis of rotation of the wheel, denoted O.

However, according to a preferred embodiment, the sensor 24 is connected directly, via a local computer network (LAN), to all of the controllers 37. In this case, so that the information transmitted by the sensor 24 via the network is readable by the controllers, the sensor 24 preferably integrates an analog/digital converter.

Each slave controller 37 is, for its part, programmed for:
Taking into account the instantaneous angular position of the wheel 23 as soon as this position is communicated to it by the master control unit 36 or directly by the angular position sensor 24,
Deducing from it the angular position of the forming station or each forming station 10 associated with the slave controller 37 and directed by the latter, and
Plotting the blow-molding curve from pressures measured in the nozzle 25 of each associated mold, at times corresponding to each of these angular positions.

The calculation of the instantaneous angular position of each forming station 10 can be carried out in the following simple manner by taking as a reference (i.e., the zero angle) the loading point 21 (also denoted C in FIG. 3).

Denoted as A is a fixed arbitrary point on the wheel 23, considered to be a moving reference providing the angular position of the loading point C, denoted a and provided by the position sensor 24, such that ∝= [symbol] .

Denoted as B is the point corresponding to the relative angular position, denoted β, of the forming station 10, measured relative to the point A and such that β= [symbol] .

By denoting as θ the absolute angular position of the forming station 10 in the fixed polar frame of reference that has the OC axis as its origin, this angular position θ is such that θ= [symbol] = [symbol] + [symbol] =α+β.

Denoted as D is the unloading point 22 (fixed in the polar frame of reference of the OC axis), whose angular position, denoted γ, is such that γ= [symbol] .

Thus, for any forming station 10, the processor 39 of the associated controller, into the memory 38 of which the values of the angles β and γ are entered, is at any time capable of calculating the angle θ by the formula indicated above and of determining if the forming station 10 is located in the forming sector F, in which 0≦θ≦2π−γ (with the angles being expressed in terms of radians) or in the buffer sector T, in which θ>2π−γ.

The result from the architecture of the control system 34 is that the tasks necessary to the operation of the forming unit 9 are shared between the master control unit 36 and the slave controllers 37 that are tied to it.

The tasks attributed to the controllers 37 comprise the effective directing of the forming stations 10 (in particular two stations 10 by each controller 37), the taking of measurements, and the analysis of these measurements for deducing from them singular points S. These tasks are carried out in real time, as the cycle advances, and require a rapid processing.

The tasks attributed to the control unit 36 comprise the analysis of data communicated at each end of the cycle by the controllers 37, making the decision as to whether it is appropriate or not to correct the forming instructions CF, as well as the optional issuing and loading of corrected forming instructions CF. These tasks are carried out for each forming station 10 in delayed time, during which the latter passes through the buffer sector T when the instruction corrections are provided to be applied from one cycle to the next, or during multiple cycles, when the control unit 36 makes calculations of characteristic points on the basis of averages of measurements made over multiple cycles.

This sharing of tasks makes it possible to limit both the volume of data to be processed and the speed at which these data are to be processed by the control unit 36. In this way, the calculations necessary to the correct conduct of the forming operations do not limit the pace of production.

As is furthermore shown in a diagram in FIG. 2, the heating unit 4 is also equipped with a dedicated control system 35 that comprises a master control unit 46 and a series of slave controllers 47 tied to the master control unit 46.

The master control unit 46 is computerized and comprises:
A memory 48 into which programs for directing heating modules 5 are entered,
A processor 49 connected to the memory 48 for applying the instructions of the programs, and
A communication interface 50 connected to the processor 49 for communication with external communicating entities.

Each slave controller 47 is a programmable logic controller of the type described in W. Bolton, Programmable Logic Controllers, Newnes, 5^{th} Edition, 2009.

More specifically, each controller 47 comprises:
A memory 51 into which programs for directing at least one heating module 5 are entered,
A processor 52 connected to the memory 51 for applying the instructions of the program,
A communication interface 53 connected to the processor 49 for communication with the master control unit 46 via its own communication interface 50,
An input interface 54 connected, on the one hand, to the processor 52, and, on the other hand, to the heat sensor 20,
An output interface 55 connected, on the one hand, to the processor 52, and, on the other hand, to the power variable-speed drive unit 19 and to the motors 14, 18 of the driving wheel 13 and the fan 17.

The controller 47 is programmed to carry out the following operations:
Directing the heating module or each heating module 5 with which it is associated, according to a heating instruction CC that is loaded (i.e., written) into the memory 51;
Based on the measurement of temperature (denoted T) obtained from the heat sensor 20, plotting the instantaneous thermal profile of each preform 3, which can come in the form of a mean temperature measured for the entire preform 3, of a set of multiple temperature values at different heights in the body of the preform 3, or a curve providing the temperature T based on the height (denoted h) in the preform 3;
Analyzing the thermal profile and extracting from it the coordinates of at least one singular point W (for example, at a given height in the vicinity of the neck);
Communicating for each preform 3, or at predetermined intervals, the coordinates of the singular point W to the master control unit 46.

The heating instruction CC can comprise a power value delivered by the variable-speed drive unit 19, a speed of rotation of the motor 18 of the fan 17, or else a speed of rotation of the driving wheel 13 (and therefore, consequently, a travel speed of the preforms 3—in other words, the pace of production of the oven 4).

The processor 49 of the master control unit 46 is, for its part, programmed for:
Directing its slave controllers 47,
Taking into account the singular point or each singular point W communicated by each controller 47,
Calculating a characteristic point CW from the singular point(s) W. This characteristic point CW can be the singular point W communicated at a predetermined time by the controller 47 or an average of singular points W communicated during a predetermined period by the same controller 47;
Comparing this characteristic point CW with a theoretical point entered in advance into the memory 48 of the master control unit 46 and corresponding to a preform that has provided a model container,
If a variation is declared between the characteristic point CW and the theoretical point, issuing a corrected heating instruction CC, comprising a value modified for the power of the variable-speed drive unit 19, or else for the speed of rotation of the motor 18 of the fan 17 or of the driving wheel 13;
Loading the corrected heating instruction CC into the controller or each controller 47 directed by the master control unit 46;
If necessary, communicating the characteristic point CW to the central control unit 33.

When no variation is declared between the characteristic point CW and the theoretical point, no corrected heating instruction is issued by the processor, so that the controller 47 continues directing the (or each) heating module 5 according to the preceding heating instruction CC.

As is illustrated in the figures, the central control unit 33 of the installation 1 comprises:
A memory 56 into which programs for directing the control units 36, 46 of the dedicated control systems 34, 35 are entered, with these control units 36, 46 thus being tied to the central control unit 33 (in other words, the control units 36, 46 are masters of the controllers 37, 47 and slaves of the central control unit 33);
A processor 57 connected to the memory 56 for applying the instructions of the programs, and
A communication interface 58 connected to the processor 57 for communication with the control units 36, 46.

The processor 57 of the central control unit 33 is programmed to direct each control unit 36, 46, according to a processing instruction CF, CC that is loaded into the processor 39, 49 of each control unit 36, 46.

It is seen that the control units 36, 46 can transmit to the central control unit 33 the characteristic points CS, CW.

This transmission makes it possible for the processor 57 of the central control unit 33 to direct the operation of each processing unit 4 (or 9) as a function of measurements obtained from another processing unit 9 (or 4).

More specifically, the processor 57 of the central control unit 33 is programmed for:
Taking into account at least one characteristic point CS, CW that is communicated to it by a first control unit 36 (or 46),
Comparing this characteristic point with a theoretical point entered into the memory 56 of the central control unit 33,
If a variation is declared between the singular point and the theoretical point, issuing a corrected processing instruction CC, CF intended for a second control unit 46 (or 36), and
Loading this corrected processing instruction CC, CF into the second control unit 46 (or 36).

This sequence of operations can be triggered in particular in the case where a first instruction correction made at the level of a dedicated control system 34 (or 35) to a given processing unit 9 (or 4) does not eliminate (or does not diminish), in the following cycle (or in a predetermined number of cycles), the variation noted between the characteristic point CS, CW and the theoretical point.

It can also be triggered in the case where it is known (and therefore programmed) that only the correction of a processing instruction CC, CF intended for the second control unit 46 (or 36) is able to affect (and therefore to correct) the measurements made in the first processing unit 9 (or 4).

In the example illustrated, the quality of the final container 2 obtained at the outlet of the forming unit 9 depends in particular on the heating temperature T, which is regulated in the heating unit 4. The temperature T for heating preforms 3 can actually vary as a function of:
The intensity of the radiation delivered by the heating modules 5, which depends on the electrical power that is delivered to them, modulated by the variable-speed drive unit 19,
The power of the ventilation, regulated by the speed of rotation of the fan 17, which is modulated by the motor 18,
The travel speed of the preforms 3, which is modulated by the motor 14 of the wheel 13.

Thus, it is understood that an instruction change CC affecting the heating temperature T within the heating unit 4 will have the effect of a modification of the blow-molding curve, and in particular the position of the singular point S detected in the latter by the processor 39 of the controller 37. This instruction change CC is made according to the following procedure, thanks to the programming described above:
After having plotted the blow-molding curve, the controller 37 analyzes it and extracts from it the coordinates of the singular point S (typically the point B) and communicates these coordinates to the control unit 36 of the forming unit 9;
Having declared that a modification of the forming instruction CF is inadequate for obtaining the desired correction of the position of the singular point S on the blow-molding curve in the following cycle or in a predetermined number of following cycles, the control unit 36 communicates the coordinates of the characteristic point CS to the central control unit 33;
The central control unit 33, programmed for this purpose, determines that the blow-molding curve can be corrected using a modification of the heating temperature T, or of the speed of rotation of the fan 17, or else the travel speed of the preforms 3 (in other words, the speed of rotation of the wheel 13) and issues a corrected heating instruction CC to the attention of the control unit 46 of the heating unit 4;
The central control unit 33 loads the thus corrected heating instruction CC into the control unit 46 of the heating unit 4;
The control unit 46 directs the controllers 47 by applying the thus corrected heating instruction CF.

This architecture has the following advantages.

First of all, it makes it possible to unclog the control system 32 of the installation by sharing the tasks among multiple control levels connected to one another according to the master-slave principle:
The controllers 37, 47 are programmed to conduct low-level operations over the short term, including the (analog) control of mechanical components;
The control units 36, 46 are programmed to conduct intermediate-level operations over a relatively longer term, including the calculation of characteristic points (in particular, averages) as a function of measurements received from the controllers 37, 47, the comparison with reference values, the issuing of instructions (optionally corrected) and the directing, as a function of these instructions, of the controllers 37, 47;
The central control unit 33 is programmed to conduct higher-level operations over the long term, including taking into account data communicated by the control units 36, 46, the issuing of instructions, and directing, as a function of these instructions, the control units 36, 46.

Secondly, this architecture makes possible a dialogue between the different processing units 4, 9 of the installation 1 without it being necessary to centralize all of the operations within the central control unit 33, to which only tasks of decision-making, correcting instructions CF, CC and loading corrected instructions CF, CC into the control units 36, 46 that are tied to it can be assigned.

Thirdly, thanks to the dialogue between the different control levels, the programming of the entire control system 32 can be centralized on the higher level, i.e., in the central control unit 33, which can relay to the control units 36, 46 the program that is dedicated to them as well as the program dedicated to the controllers 37, 47, with the control units 36, 46 relaying in their turn to the controllers 37, 47 the program dedicated to the latter. It is therefore unnecessary to load the programs individually into each controller 37, 47 or even into each control unit 36, 46. The result is a simplification of the programming of the installation and an increased productivity.

Fourthly, this architecture makes it possible to carry out a transverse retroaction, i.e., to control a modification of the instruction applied by a processing unit—typically the heating unit 4—as a function of measurements made within another processing unit—typically the forming unit 9. The quality of the containers produced is improved.

1. Control system (32) of an installation (1) for producing containers (2) from blanks (3) made of thermoplastic material, with this installation (1) comprising at least two units (4, 9) for processing blanks (3) or containers (2), each equipped with at least one station (5, 10) for processing blanks (3) or containers (2), characterized in that it comprises a central control unit (33) of the installation (1), at least two control units (36, 46) tied to the central control unit (33) and each associated respectively with a processing unit (9, 4), and at least two controllers (37, 47), each tied to a control unit (36, 46) and each associated with at least one processing station (10, 5).

2. System (32) according to claim 1, wherein the central control unit (33) is programmed for:
Directing each attached control unit (36) according to a processing instruction (CF) that is loaded into the control unit (36),
Taking into account at least one characteristic point (CS) in the central unit (33) by the control unit (36),
Comparing this characteristic point (CS) with a theoretical point,
If a variation is declared between the characteristic point (CS) and the theoretical point, issuing a corrected processing instruction (CC) intended for a second control unit (46),
Loading the corrected processing instruction (CC) into the second control unit (46).

3. Control system (32) according to claim 2,
wherein each control unit (36) is programmed for:
Directing each attached controller (37) according to the processing instruction (CF) that is loaded by the central unit (33),
Taking into account at least one singular point (S) obtained from a measurement made on at least one processing station (10) of a first processing unit (9) for control of a controller (37),
Calculating a characteristic point (CS) as a function of the singular point(s) (S),
Comparing the characteristic point (CS) with a theoretical point,
If a variation is declared between the characteristic point (CS) and the theoretical point justifying a modification of the processing instruction (CC) of another processing unit (4), communicating the characteristic point (CS) to the central control unit (33).

4. Control system (32) according to claim 3, wherein each controller (37) is programmed for:
Directing at least one processing station (10) according to the processing instruction (CF),
Controlling at least one measurement at the level of the processing station (10),
Based on this measurement, plotting a curve describing a variation of this measurement,
Analyzing the curve and extracting from it the coordinates of a singular point (S),
Communicating the singular point (S) to the control unit (36).

5. Installation (1) for producing containers (2) from blanks (3) made of thermoplastic material, with this installation comprising at least two units (4, 9) for processing blanks (3) or containers (2), each equipped with at least one station (5, 10) for processing blanks (3) or containers (2), wherein it also comprises a control system (32) according to claim 1.

6. Installation (1) according to claim 5, wherein one of the processing units is a unit (4) for heating blanks (3), and another processing unit is a forming unit (9) equipped with at least one station (10) for forming containers (2) from blanks (3).

7. Installation (1) for producing containers (2) from blanks (3) made of thermoplastic material, with this installation comprising at least two units (4, 9) for processing blanks (3) or containers (2), each equipped with at least one station (5, 10) for processing blanks (3) or containers (2), wherein it also comprises a control system (32) according to claim 2.

8. Installation (1) for producing containers (2) from blanks (3) made of thermoplastic material, with this installation comprising at least two units (4, 9) for processing blanks (3) or containers (2), each equipped with at least one station (5, 10) for processing blanks (3) or containers (2), wherein it also comprises a control system (32) according to claim 3.

9. Installation (1) for producing containers (2) from blanks (3) made of thermoplastic material, with this installation comprising at least two units (4, 9) for processing blanks (3) or containers (2), each equipped with at least one station (5, 10) for processing blanks (3) or containers (2), wherein it also comprises a control system (32) according to claim 4.
